(19) United States
(12) Patent Application Publication
(10) Pub. No.: US 2024/0154289 A1
(43) Pub. Date: May 9, 2024

(54) Waveguide With A Zigzag For Suppressing Grating Lobes

(71) Applicant: Aptiv Technologies Limited, St. Michael (BB)

(72) Inventor: Mingjian LI, Santa Clara, CA (US)

(73) Assignee: Aptiv Technologies Limited, St. Michael (BB)

(21) Appl. No.: 18/406,536

(22) Filed: Jan. 8, 2024

Related U.S. Application Data
(62) Division of application No. 17/234,299, filed on Apr. 19, 2021, now Pat. No. 11,901,601.
(60) Provisional application No. 63/169,078, filed on Mar. 31, 2021.
(60) Provisional application No. 63/127,819, filed on Dec. 18, 2020.
(60) Provisional application No. 63/127,861, filed on Dec. 18, 2020.
(60) Provisional application No. 63/127,873, filed on Dec. 18, 2020.

(51) Int. Cl. H01P 3/12; H01Q 13/10

(52) U.S. Cl. CPC H01P 3/121; H01Q 13/10

(57) ABSTRACT

A waveguide includes a printed circuit board (PCB) having a first conductive layer, a second substrate layer, and a third conductive layer. The waveguide includes a hollow channel for a dielectric that includes a first opening in a longitudinal direction through the hollow channel at one end of the waveguide and a closed wall at an opposite end of the waveguide, the third conductive layer forming a surface of the hollow channel that defines the hollow channel and a plurality of radiation slots, each of the plurality of radiation slots comprising a second opening formed in the second substrate layer, each of the plurality of radiation slots being operably connected with the dielectric.

### CROSS-REFERENCE TO RELATED APPLICATIONS

This application is a divisional application of U.S. application Ser. No. 17/234,299, filed Apr. 19, 2021, which application claims the benefit under 35 U.S.C. 119(e) of U.S. Provisional Application No. 63/169,078, filed Mar. 31, 2021, and U.S. Provisional Application Nos. 63/127,819, 63/127,861, and 63/127,873, each filed Dec. 18, 2020. The disclosures of each of the above applications are incorporated by reference in their entirety herein.

### BACKGROUND

Some devices (e.g., radar systems) use electromagnetic (EM) signals to detect and track objects. The EM signals are transmitted and received using one or more antennas. Many automotive applications use radar systems to detect objects near the vehicle (e.g., in a particular portion of a travel path of the vehicle). Some automotive radar systems use a waveguide slot array antenna to avoid loss (e.g., dielectric loss and metal loss) associated with substrate integrated waveguide (SIW) slot arrays and microstrip line-fed patch arrays. Such waveguides may suffer from grating lobes in the three-dimensional radiation pattern of the antenna. These grating lobes can cause automotive radar systems to malfunction, resulting in an inability to detect nearby objects.

### SUMMARY

This document describes techniques, apparatuses, and systems for a waveguide with a zigzag for suppressing grating lobes. An apparatus may include a waveguide for providing a three-dimensional radiation pattern. The waveguide includes a hollow channel containing a dielectric. The hollow channel includes an opening in a longitudinal direction through the waveguide at one end and a closed wall at an opposite end of the waveguide. The hollow channel forms a zigzag shape along the longitudinal direction. The waveguide also includes an array of radiation slots that each provide an opening through a surface of the waveguide that defines the hollow channel. The openings of the radiation slots are operably connected with the dielectric. The zigzag waveguide channel and the radiation slots configure the described waveguide to suppress grating lobes in an antenna radiation pattern.

This document also describes methods performed by the above-summarized techniques, apparatuses, and systems, and other methods set forth herein, as well as means for performing these methods.

This Summary introduces simplified concepts related to a waveguide with a zigzag for suppressing grating lobes, further described in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of a waveguide with a zigzag for suppressing grating lobes are described in this document with reference to the following figures. The same numbers are often used throughout the drawings to reference like features and components:

FIG. 1 illustrates an example environment in which a radar system with a waveguide including a zigzag for suppressing grating lobes is used on a vehicle, in accordance with techniques, apparatuses, and systems of this disclosure;

FIGS. 2A and 2B illustrate a top view and a cross-section view, respectively, of a waveguide with a zigzag waveguide channel for suppressing grating lobes;

FIGS. 3A and 3B illustrate three-dimensional radiation patterns associated with example radar systems with and without zigzag waveguide channels, respectively;

FIG. 4 illustrates radiation patterns in a diagonal plane associated with example radar systems with and without zigzag waveguide channels;

FIGS. 5A and 5B illustrate views of another example waveguide formed in part with a printed circuit board to have a zigzag arrangement of radiation slots;

FIGS. 6A and 6B illustrate views of another example waveguide that is formed in part with a printed circuit board to have a zigzag waveguide channel for suppressing grating lobes;

FIG. 7 illustrates an example method for manufacturing a waveguide with a zigzag waveguide for suppressing grating lobes following techniques, apparatuses, and systems of this disclosure.

FIG. 8 illustrates an example method for forming a waveguide in part with a printed circuit board, following techniques, apparatuses, and systems of this disclosure.

### DETAILED DESCRIPTION

Overview

Radar systems are a sensing technology that some automotive systems rely on to acquire information about the surrounding environment. Radar systems generally use an antenna to direct EM energy or signals being transmitted or received. Such radar systems can use multiple antenna elements in an array to provide increased gain and directivity in comparison to the radiation pattern achievable with a single antenna element. Signals from the multiple antenna elements are combined with appropriate phases and weighted amplitudes to provide the desired radiation pattern.

Consider a waveguide used to transfer EM energy to and from the antenna elements. The waveguide generally includes an array of radiation slots (also sometimes referred to as “radiating slots”) representing apertures in the waveguide. Manufacturers may select the number and arrangement of the radiation slots to provide the desired phasing, combining, or splitting of EM energy. For example, the radiation slots are equally spaced at a wavelength distance apart in a waveguide surface along a propagation direction of the EM energy. This arrangement of radiation slots generally provides a wide radiation pattern with relatively uniform radiation in the azimuth plane but may also includes grating lobes in the three-dimensional radiation pattern. The grating lobes can have approximately the same intensity as the main lobe in the radiation pattern and cause a radar system to malfunction.

This document describes a waveguide with a zigzag for suppressing grating lobes in the three-dimensional radiation pattern of a radar system. The waveguide includes a hollow channel for a dielectric. The hollow channel includes an opening in a longitudinal direction through the waveguide and a closed wall at an opposite end of the waveguide. The hollow channel forms a zigzag shape along the longitudinal direction. The waveguide also includes multiple radiation slots that form an opening through a surface that defines the hollow channel. The zigzag waveguide channel allows the radiation slots to be aligned along the longitudinal direction. The zigzag waveguide channel also suppress grating lobes in the radiation pattern of the described radar system.

The described waveguide may be particularly advantageous for use in an automotive context, for example, detecting objects in a roadway in a travel path of a vehicle. The suppression of grating lobes allows a radar system of the vehicle to avoid large sidelobes that can cause the radar system to malfunction and fail to detect objects. As one example, a radar system placed near the front of a vehicle can use the zigzag waveguide to provide a three-dimensional radiation pattern with minimal sidelobes in order to detect objects immediately in front of the vehicle.

This example waveguide is just one example of the described techniques, apparatuses, and systems of a waveguide with a zigzag waveguide channel for suppressing grating lobes. This document describes other examples and implementations.

Operating Environment

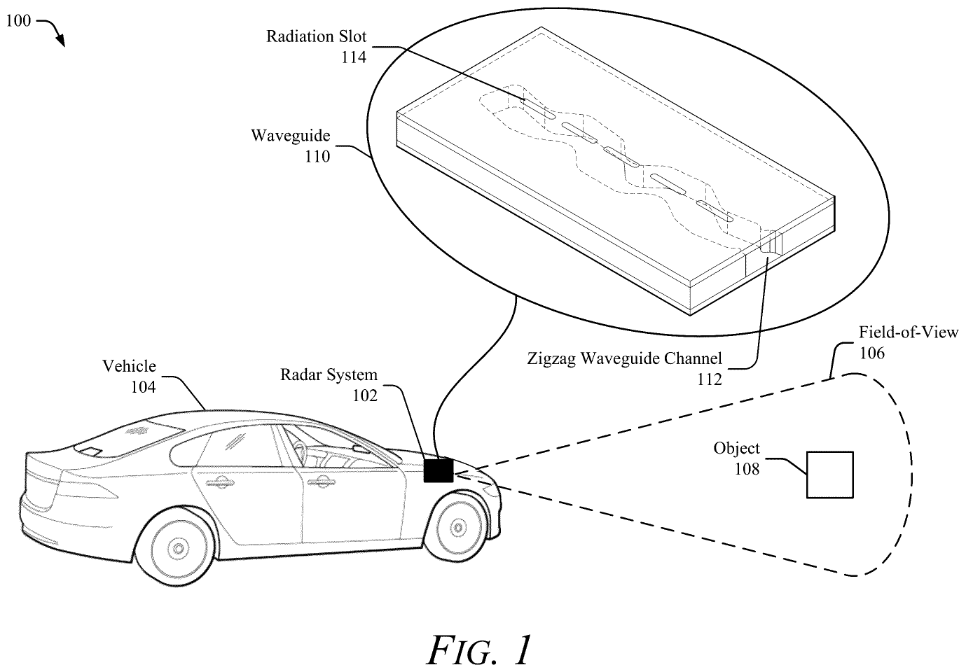

FIG. 1 illustrates an example environment 100 in which a radar system 102 with a zigzag for suppressing grating lobes is used on a vehicle 104, in accordance with techniques, apparatuses, and systems of this disclosure. The vehicle 104 may use a waveguide 110 to enable operations of the radar system 102 that is configured to determine a proximity, an angle, or a velocity of one or more objects 108 in the proximity of the vehicle 104.

Although illustrated as a car, the vehicle 104 can represent other types of motorized vehicles (e.g., a motorcycle, a bus, a tractor, a semi-trailer truck, or construction equipment), non-motorized vehicles (e.g., a bicycle), railed vehicles (e.g., a train or a trolley car), watercraft (e.g., a boat or a ship), aircraft (e.g., an airplane or a helicopter), or spacecraft (e.g., satellite). In general, manufacturers can mount the radar system 102 to any moving platform, including moving machinery or robotic equipment. In other implementations, other devices (e.g., desktop computers, tablets, laptops, televisions, computing watches, smartphones, gaming systems, and so forth) may incorporate the radar system 102 with the waveguide 110 and support techniques described herein.

In the depicted environment 100, the radar system 102 is mounted near, or integrated within, a front portion of the vehicle 104 to detect the object 108 and avoid collisions. The radar system 102 provides a field-of-view 106 towards the one or more objects 108. The radar system 102 can project the field-of-view 106 from any exterior surface of the vehicle 104. For example, vehicle manufacturers can integrate the radar system 102 into a bumper, side mirror, headlights, rear lights, or any other interior or exterior location where the object 108 requires detection. In some cases, the vehicle 104 includes multiple radar systems 102, such as a first radar system 102 and a second radar system 102 that provide a larger field-of-view 106. In general, vehicle manufacturers can design the locations of the one or more radar systems 102 to provide a particular field-of-view 106 that encompasses a region of interest, including, for instance, in or around a travel lane aligned with a vehicle path.

Example fields-of-view 106 include a 360-degree field-of-view, one or more 180-degree fields-of-view, one or more 90-degree fields-of-view, and so forth, which can overlap or be combined into a field-of-view 106 of a particular size. As described above, the described waveguide 110 includes a zigzag waveguide channel 112 and multiple radiation slots 114 to provide a radiation pattern with suppressed grating lobes in the three-dimensional radiation pattern of the radar system 102. As one example, a radar system 102 placed near the front corner (e.g., the front left corner) of a vehicle 104 can use the radiation pattern to focus on detecting objects immediately in front of the vehicle and avoid potential malfunction caused by grating lobes. For example, the zigzag waveguide channel 112 can concentrate the radiated EM energy within 60 degrees of a diagonal plane. In contrast, a waveguide without the described zigzag waveguide channel 112 may provide a radiation pattern with large side lobes (e.g., grating lobes) at around ±60 degrees and cause the radar system 102 to malfunction or inaccurately detect objects 108 in the travel path of the vehicle 104.

The object 108 is composed of one or more materials that reflect radar signals. Depending on the application, the object 108 can represent a target of interest. In some cases, the object 108 can be a moving object or a stationary object. The stationary objects can be continuous (e.g., a concrete barrier, a guard rail) or discontinuous (e.g., a traffic cone) along a road portion.

The radar system 102 emits EM radiation by transmitting one or more EM signals or waveforms via the radiation slots 114. In the environment 100, the radar system 102 can detect and track the object 108 by transmitting and receiving one or more radar signals. For example, the radar system 102 can transmit EM signals between 100 and 400 gigahertz (GHz), between 4 and 100 GHz, or between approximately 70 and 80 GHz.

The radar system 102 can determine a distance to the object 108 based on the time it takes for the signals to travel from the radar system 102 to the object 108 and from the object 108 back to the radar system 102. The radar system 102 can also determine the location of the object 108 in terms of an angle based on the direction of a maximum amplitude echo signal received by the radar system 102.

The radar system 102 can be part of the vehicle 104. The vehicle 104 can also include at least one automotive system that relies on data from the radar system 102, including a driver-assistance system, an autonomous-driving system, or a semi-autonomous-driving system. The radar system 102 can include an interface to the automotive systems. The radar system 102 can output, via the interface, a signal based on EM energy received by the radar system 102.

Generally, the automotive systems use radar data provided by the radar system 102 to perform a function. For example, the driver-assistance system can provide blind-spot monitoring and generate an alert indicating a potential collision with the object 108 detected by the radar system 102. In this case, the radar data from the radar system 102 indicates when it is safe or unsafe to change lanes. The autonomous-driving system may move the vehicle 104 to a particular location on the road while avoiding collisions with the object 108 detected by the radar system 102. The radar data provided by the radar system 102 can provide information about a distance to and the location of the object 108 to enable the autonomous-driving system to perform emergency braking, perform a lane change, or adjust the speed of the vehicle 104.

The radar system 102 generally includes a transmitter (not illustrated) and at least one antenna, including the waveguide 110, to transmit EM signals. The radar system 102 generally includes a receiver (not illustrated) and at least one antenna, including the waveguide 110, to receive reflected versions of these EM signals. The transmitter includes components for emitting EM signals. The receiver includes components to detect the reflected EM signals. The transmitter and the receiver can be incorporated together on the same integrated circuit (e.g., a transceiver integrated circuit) or separately on different integrated circuits.

The radar system 102 also includes one or more processors (not illustrated) and computer-readable storage media (CRM) (not illustrated). The processor can be a microprocessor or a system-on-chip. The processor executes instructions stored within the CRM. As an example, the processor can control the operation of the transmitter. The processor can also process EM energy received by the antenna and determine the location of the object 108 relative to the radar system 102. The processor can also generate radar data for the automotive systems. For example, the processor can control, based on processed EM energy from the antenna, an autonomous or semi-autonomous driving system of the vehicle 104.

The waveguide 110 includes at least one layer that can be any solid material, including wood, carbon fiber, fiberglass, metal, plastic, or a combination thereof. The waveguide 110 can also include a printed circuit board (PCB). The waveguide 110 is designed to mechanically support and electrically connect components (e.g., the zigzag waveguide channel 112, the radiation slots 114) to a dielectric using conductive materials. The zigzag waveguide channel 112 includes a hollow channel to contain the dielectric (e.g., air). The radiation slots 114 provide an opening through a layer or surface of the waveguide 110. The radiation slots 114 are configured to allow EM energy to dissipate to the environment 100 from the dielectric in the zigzag waveguide channel 112. The EM energy dissipates through the radiation slots 114 to produce a three-dimensional radiation pattern within the field-of-view 106 with grating lobes suppressed or eliminated.

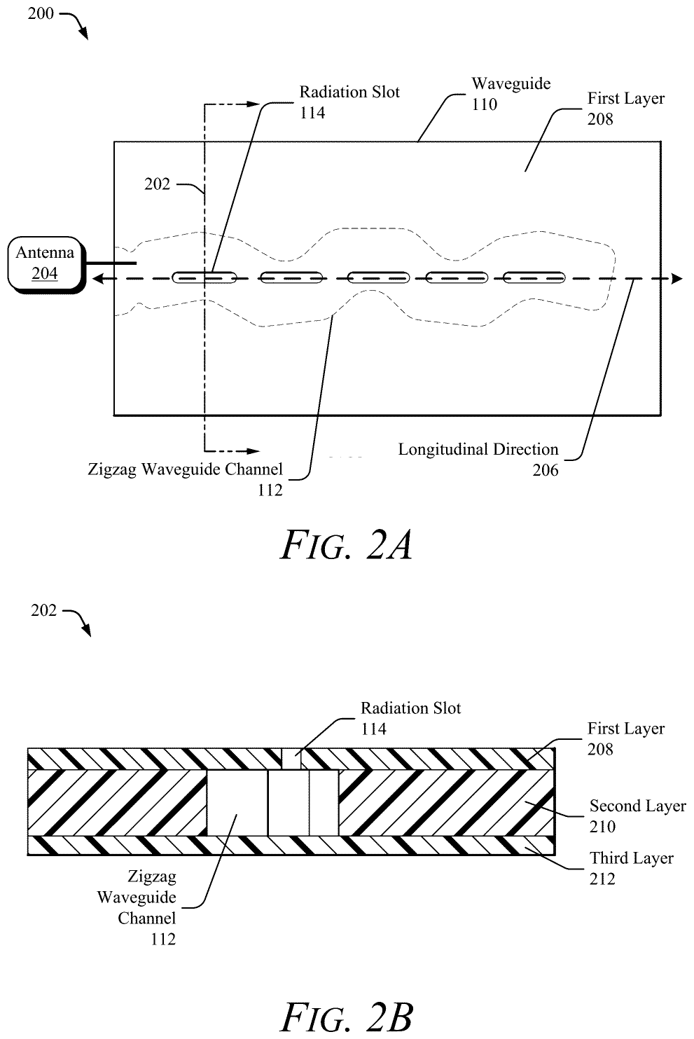

This document describes example embodiments of the waveguide 110 to suppress grating lobes in an antenna radiation pattern in greater detail with respect to FIGS. 2 through 4 and 7. The suppression of grating lobes in the radiation pattern allows a radar system 102 of the vehicle 104 to detect objects 108 in a particular portion of the field-of-view 106 (e.g., immediately in front of the vehicle) without potential misidentification of the objects 108 or malfunction.

FIGS. 2A and 2B illustrate a top view 200 and a cross-section view 202, respectively, of the waveguide 110 with the zigzag waveguide channel 112 for suppressing grating lobes. As described with respect to FIG. 1, the waveguide 110 includes the zigzag waveguide channel 112 and multiple radiation slots 114.

The zigzag waveguide channel 112 is configured to channel EM signals transmitted by the transmitter and an antenna 204. The antenna 204 can be electrically coupled to a floor of the zigzag waveguide channel 112. The floor of the zigzag waveguide channel 112 is opposite a first layer 208, through which the radiation slots are formed.

The zigzag waveguide channel 112 can include a hollow channel for a dielectric. The dielectric generally includes air, and the waveguide 110 is an air waveguide. The zigzag waveguide channel 112 forms an opening in a longitudinal direction 206 at one end of the waveguide 110 and a closed wall at an opposite end. The antenna 204 is electrically coupled to the dielectric via the floor of the zigzag waveguide channel 112. EM signals enter the zigzag waveguide channel 112 through the opening and exit the zigzag waveguide channel 112 via the radiation slots 114.

As illustrated in FIG. 2A, the zigzag waveguide channel 112 forms a zigzag shape in the longitudinal direction 206. The zigzag shape of the zigzag waveguide channel 112 can reduce or eliminate grating lobes in the radiation pattern that a straight or rectangular waveguide shape can introduce. The turns in the zigzag shape can include various turning angles to provide the zigzag shape in the longitudinal direction 206. The zigzag shape may include multiple turns along the longitudinal direction, for example, with each of the multiple turns having a turning angle between 0 and 90 degrees.

The radiation slots 114 provide an opening through a first layer 208 that defines a surface of the zigzag waveguide channel 112. For example, the radiation slots 114 can have an approximately rectangular shape (e.g., a longitudinal slot parallel to the longitudinal direction 206) as illustrated in FIG. 2A. The longitudinal slots allow the radiation slots 114 to produce a horizontal-polarized radiation pattern. The radiation slots 114 can have other shapes in other implementations, including approximately circular, oval, or square.

The radiation slots 114 are sized and positioned on or in the first layer 208 to produce a particular radiation pattern for the antenna 204. For example, the plurality of radiation slots 114 can be evenly distributed along the zigzag waveguide channel 112 between the opening of the zigzag waveguide channel 112 and the closed wall. Each adjacent pair of radiation slots 114 is separated along the longitudinal direction 206 by a uniform distance to produce a particular radiation pattern. The uniform distance, which is generally less than one wavelength of the electromagnetic radiation, can further suppress grating lobes in the radiation pattern. The zigzag shape of the zigzag waveguide channel 112 allows manufacturers to position the radiation slots 114 in an approximately straight line along the longitudinal direction 206. As another example, the radiation slots 114 nearer the wall at the opposite end of the zigzag waveguide channel 112 can have a larger longitudinal opening than the radiation slots 114 nearer the opening of the zigzag waveguide channel 112. The specific size and position of the radiation slots 114 can be determined by building and optimizing a model of the waveguide 110 to produce the desired radiation pattern.

FIG. 2B illustrates the cross-section view 202 of the waveguide 110 with the zigzag waveguide channel 112 for suppressing grating lobes. The waveguide 110 includes the first layer 208, a second layer 210, and a third layer 212. The first layer 208, the second layer 210, and the third layer 212 can be metal or metal-plated material. The radiation slots 114 form openings in the first layer 208 into the zigzag waveguide channel 112. The second layer 210 forms sides of the zigzag waveguide channel 112. The third layer 212 forms the floor of the zigzag waveguide channel 112. In the depicted implementation, the first layer 208, the second layer 210, and the third layer 212 are separate layers. In other implementations, the first layer 208, the second layer 210, and the third layer 212 can be formed as a single layer that defines the zigzag waveguide channel 112 and the radiation slots 114.

As depicted in FIG. 2B, the zigzag waveguide channel 112 forms an approximately rectangular opening in the cross-section view 202 of the waveguide 110. In other implementations, the zigzag waveguide channel 112 can form an approximately square, oval, or circular opening in the cross-section view 202. In other words, the opening to the zigzag waveguide channel 112 can have an approximately square shape, oval shape, or circular shape.

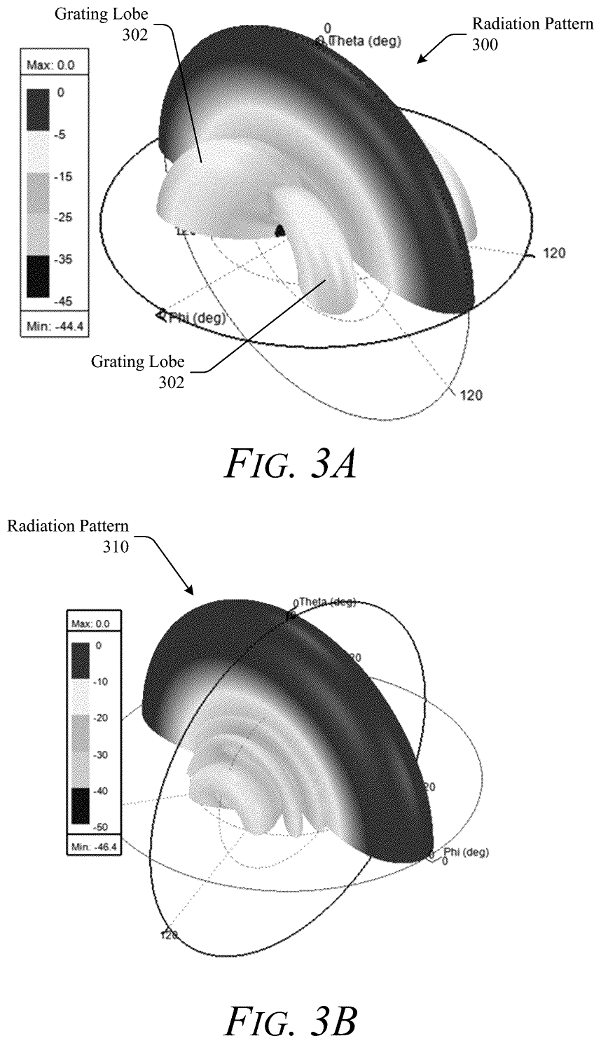

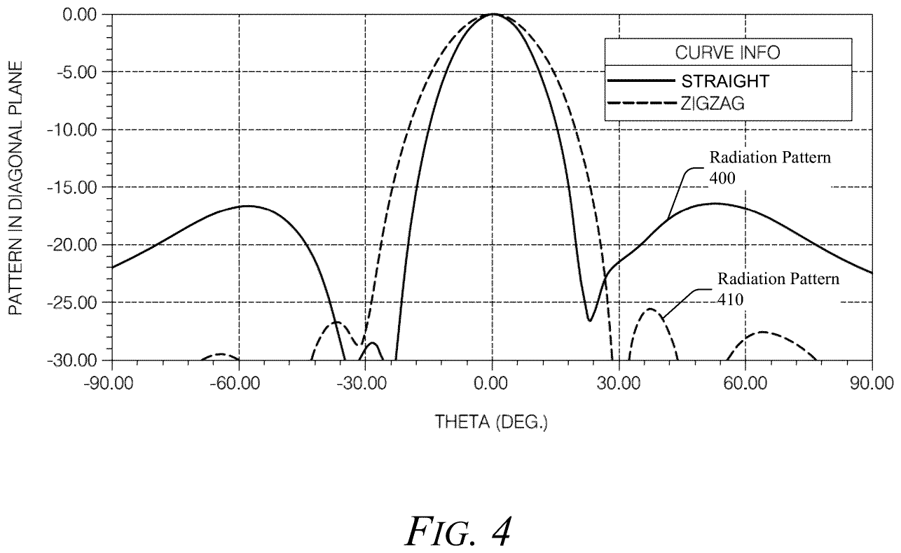

FIG. 3A illustrates a three-dimensional radiation pattern 300 associated with an example waveguide with a straight waveguide channel. The three-dimensional radiation pattern 300 includes grating lobes 302 in diagonal planes. As described in greater detail with respect to FIG. 4, the grating lobes have a relatively large intensity value and can cause the radar system 102 to malfunction.

In contrast to FIG. 3A, FIG. 3B illustrates a three-dimensional radiation pattern 310 associated with an example waveguide with a zigzag waveguide channel 112 for suppressing grating lobes. The radiation pattern 310 does not include relatively large grating lobes provides uniform radiation. The example waveguide can include the waveguide 110 illustrated in FIGS. 1 and 2 with the radiation slots 114. The waveguide 110 can generate the radiation pattern 310 with suppressed grating lobes to enable a radar system to focus the radiation pattern of a corresponding antenna on a portion of the field-of-view where potential objects-of-interest are more likely to be located than the radar system can using the radiation pattern 300 illustrated in FIG. 3A. As one example, a radar system placed near the front of a vehicle can use the radiation pattern in one plane to focus on detecting objects immediately in front of the vehicle instead of objects located toward a side of the vehicle.

FIG. 4 illustrates radiation patterns 400 and 410 in a diagonal plane associated with example radar systems without and with zigzag waveguide channels, respectively. A radar system with a straight waveguide channel can generate a radiation pattern 400 in the diagonal plane with relatively large grating lobes. For example, in FIG. 4, the maxima of the grating lobes appear at approximately ±50 degrees.

In contrast, a radar system 102 with a zigzag waveguide channel 112 generates the radiation pattern 410 in the diagonal plane. As illustrated by the radiation pattern 410 in FIG. 4, the zigzag waveguide channel 112 can suppress the grating lobes. The suppression of the grating lobes allows the radar system 102 to avoid malfunctioning and more accurately detect the objects 108 in the travel path of the vehicle 104.

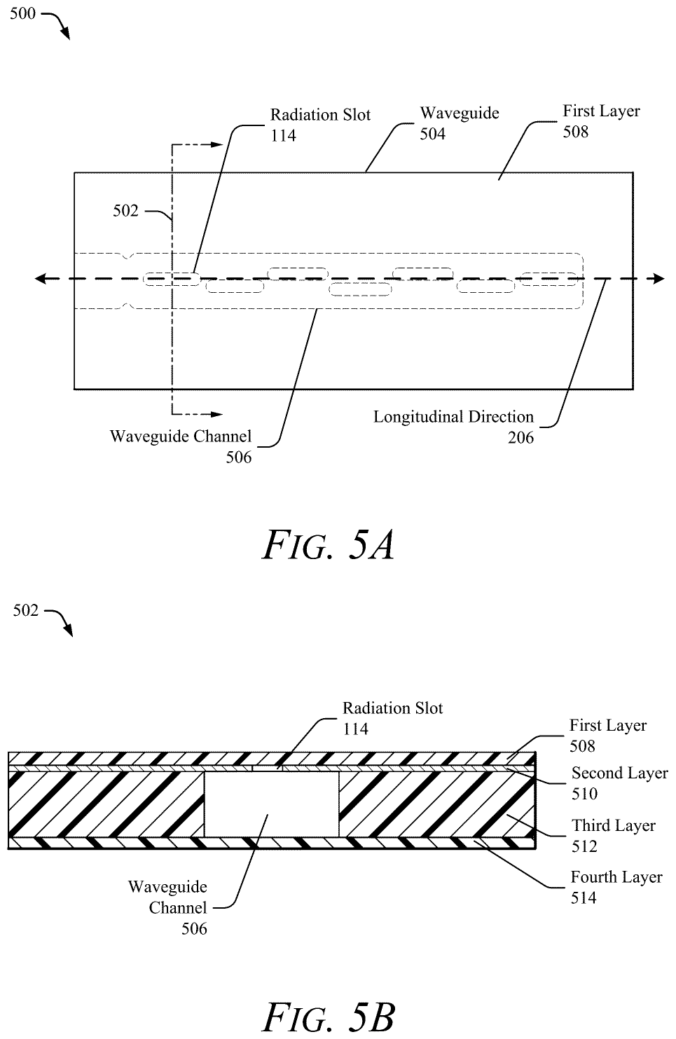

FIG. 5A illustrates a top view 500 of another example waveguide 504 formed in part with a printed circuit board (PCB) to have a zigzag arrangement of radiation slots. FIG. 5B illustrates a cross-section view 502 of the waveguide 504 with a zigzag arrangement of radiation slots. The waveguide 504 includes a waveguide channel 506 and the radiation slots 114.

The waveguide 504 includes a first layer 508, a second layer 510, a third layer 512, and a fourth layer 514. The first layer 508 and the second layer 510 provide a substrate layer and a conductive layer, respectively, of the PCB. The second layer 510 can include various conductive materials, including tin-lead, silver, gold, copper, and so forth, to enable the transport of EM energy. Like the second layer 210 and the third layer 212 illustrated in FIG. 2B, the third layer 512 and the fourth layer 514 form sides and the floor, respectively, of the waveguide channel 506. The third layer 512 and the fourth layer 514 are separate layers in the depicted implementation. In other implementations, the third layer 512 and the fourth layer 514 can be formed as a single layer and combined with the PCB structure to form the waveguide channel 506. The second layer 510 can be etched to form the radiation slots 114 as part of the conductive layer of the PCB.

The use of the PCB structure for the waveguide 504 provides several advantages over the structure of the waveguide 110 illustrated in FIGS. 2A and 2B. For example, using a PCB allows manufacturing of the waveguide 504 to be cheaper, less complicated, and easier for mass production. As another example, using a PCB provides low loss of EM radiation from the input of the waveguide channel 506 to radiation from the radiation slots 114.

The waveguide channel 506 can include a hollow channel for a dielectric. The dielectric generally includes air, and the waveguide 504 is an air waveguide. The waveguide channel 506 forms an opening in a longitudinal direction 206 at one end of the waveguide 504 and a closed wall at an opposite end. An antenna (not illustrated in FIG. 5B) can be electrically coupled to the dielectric via the floor of the waveguide channel 506. EM signals enter the waveguide channel 506 through the opening and exit the waveguide channel 506 via the radiation slots 114. In FIG. 5A, the waveguide channel 506 forms an approximately rectangular shape in the longitudinal direction 206. As discussed with respect to FIGS. 1 through 2B, the waveguide channel 506 can also form a zigzag shape in the longitudinal direction 206.

As depicted in FIG. 5B, the waveguide channel 506 can form an approximately rectangular opening in the cross-section view 502 of the waveguide 504. In other implementations, the waveguide channel 506 can form an approximately square, oval, or circular opening in the cross-section view 502 of the waveguide 504. In other words, the opening to the waveguide channel 506 can have an approximately square shape, oval shape, or circular shape.

The radiation slots 114 are sized and positioned on the second layer 510 to produce a particular radiation pattern for the antenna. For example, at least some of the radiation slots 114 are offset from the longitudinal direction 206 (e.g., a centerline of the waveguide channel 506) by varying or non-uniform distances (e.g., in a zigzag shape) to reduce or eliminate side lobes from the radiation pattern of the waveguide 504. As another example, the radiation slots 114 nearer the wall at the opposite end of the waveguide channel 506 can have a larger longitudinal opening than the radiation slots 114 nearer the opening of the waveguide channel 506. The specific size and position of the radiation slots 114 can be determined by building and optimizing a model of the waveguide 504 to produce the desired radiation pattern.

The plurality of radiation slots 114 is evenly distributed along the waveguide channel 506 between the opening of the waveguide channel and the closed wall. Each adjacent pair of radiation slots 114 are separated along the longitudinal direction 206 by a uniform distance to produce a particular radiation pattern. The uniform distance, which is generally less than one wavelength of the EM radiation, can prevent grating lobes in the radiation pattern.

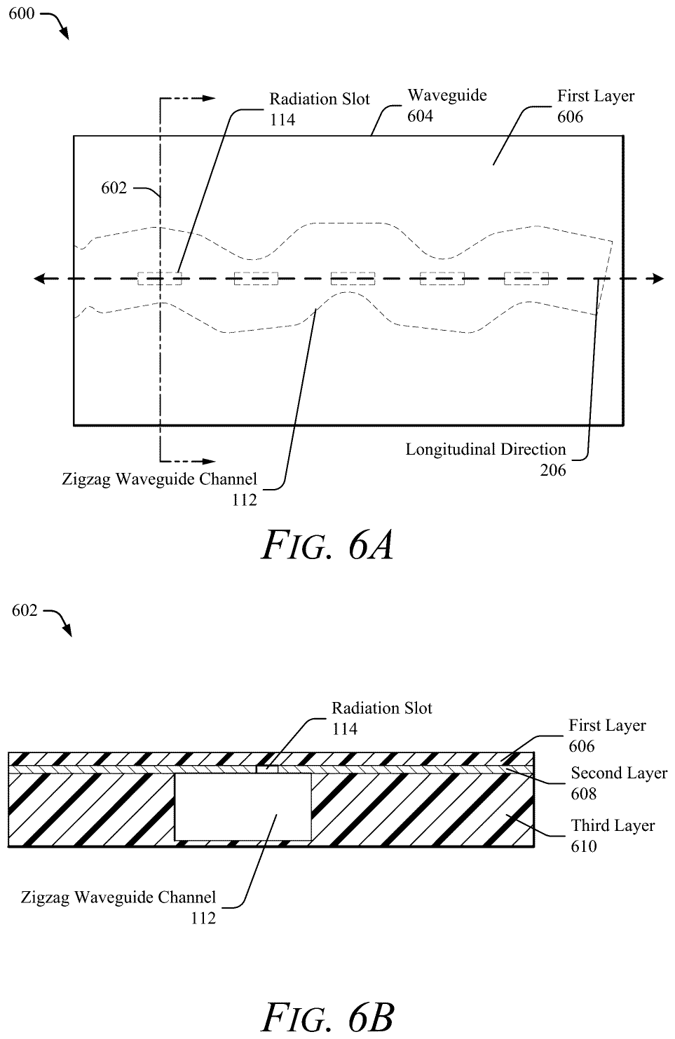

FIG. 6A illustrates a top view 600 of another example waveguide 604 formed in part with a printed circuit board (PCB) to have the zigzag waveguide channel 112. FIG. 6B illustrates a cross-section view 602 of the waveguide 604 with the zigzag waveguide channel 112. The waveguide 604 includes the radiation slots 114.

The waveguide 604 includes a first layer 606, a second layer 608, and a third layer 610. The first layer 606 and the second layer 608 provide a substrate layer and a conductive layer, respectively, of the PCB. The second layer 608 can include various conductive materials, including tin-lead, silver, gold, copper, and so forth, to enable the transport of EM energy. Like the second layer 210 and the third layer 212 illustrated in FIG. 2B, the third layer 610 forms sides and the floor, respectively, of the zigzag waveguide channel 112. The third layer 610 is a single layer in the depicted implementation. In other implementations, the third layer 610 can include multiple layers (e.g., the third layer 512 and the fourth layer 514 as illustrated for the waveguide 504 in FIG. 5B). The second layer 608 can be etched to form the radiation slots 114 as part of the conductive layer of the PCB.

The use of the PCB structure for the waveguide 604 provides several advantages over the structure of the waveguide 110 illustrated in FIGS. 2A and 2B. For example, using a PCB allows manufacturing of the waveguide 604 to be cheaper, less complicated, and easier for mass production. As another example, using a PCB provides low loss of EM radiation from the input of the zigzag waveguide channel 112 to radiation from the radiation slots 114.

As described above, the zigzag waveguide channel 112 can include a hollow channel for a dielectric. The dielectric generally includes air, and the waveguide 604 is an air waveguide. The zigzag waveguide channel 112 forms an opening in a longitudinal direction 206 at one end of the waveguide 604 and a closed wall at an opposite end. An antenna (not illustrated in FIG. 6A or 6B) can be electrically coupled to the dielectric via the floor of the zigzag waveguide channel 112. EM signals enter the zigzag waveguide channel 112 through the opening and exit the zigzag waveguide channel 112 via the radiation slots 114. In FIG. 6A, the zigzag waveguide channel 112 forms a zigzag shape in the longitudinal direction 206.

As depicted in FIG. 6B, the zigzag waveguide channel 112 can form an approximately rectangular opening in the cross-section view 602 of the waveguide 604. In other implementations, the zigzag waveguide channel 112 can form an approximately square, oval, or circular opening in the cross-section view 602 of the waveguide 604. In other words, the opening to the zigzag waveguide channel 112 can have an approximately square shape, oval shape, or circular shape.

The radiation slots 114 are sized and positioned on the second layer 608 to produce a particular radiation pattern for the antenna. For example, the plurality of radiation slots 114 can be evenly distributed along the zigzag waveguide channel 112 between the opening of the zigzag waveguide channel 112 and the closed wall. Each adjacent pair of radiation slots 114 is separated along the longitudinal direction 206 by a uniform distance to produce a particular radiation pattern. The uniform distance, which is generally less than one wavelength of the electromagnetic radiation, can further suppress grating lobes in the radiation pattern. The zigzag shape of the zigzag waveguide channel 112 allows manufacturers to position the radiation slots 114 in an approximately straight line along the longitudinal direction 206. As another example, the radiation slots 114 nearer the wall at the opposite end of the zigzag waveguide channel 112 can have a larger longitudinal opening than the radiation slots 114 nearer the opening of the zigzag waveguide channel 112. The specific size and position of the radiation slots 114 can be determined by building and optimizing a model of the waveguide 604 to produce the desired radiation pattern.

The plurality of radiation slots 114 is evenly distributed along the zigzag waveguide channel 112 between the opening of the zigzag waveguide channel and the closed wall. Each adjacent pair of radiation slots 114 are separated along the longitudinal direction 206 by a uniform distance to produce a particular radiation pattern. The uniform distance, which is generally less than one wavelength of the EM radiation, can prevent grating lobes in the radiation pattern.

### Example Methods

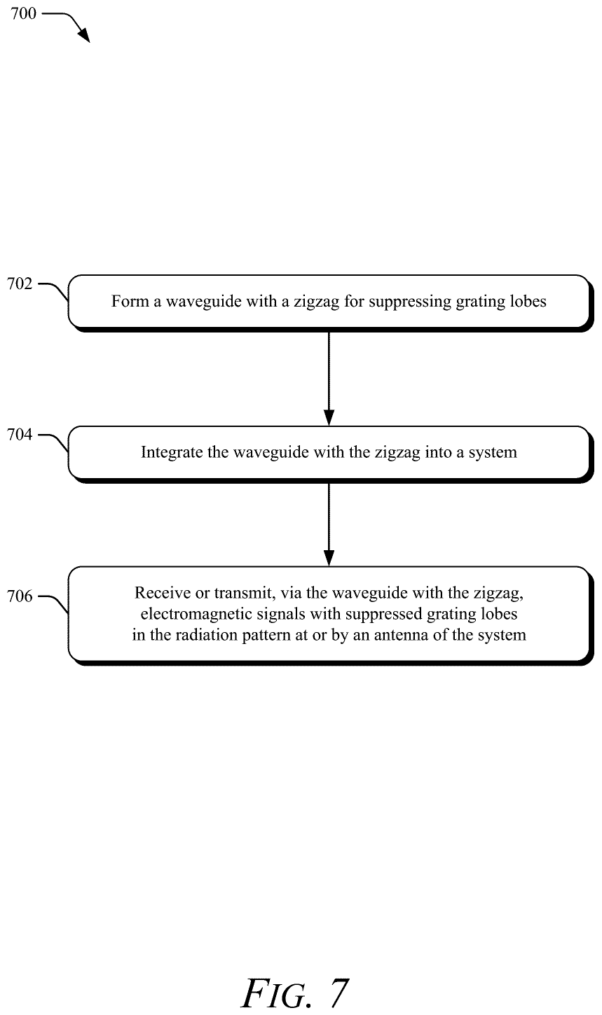

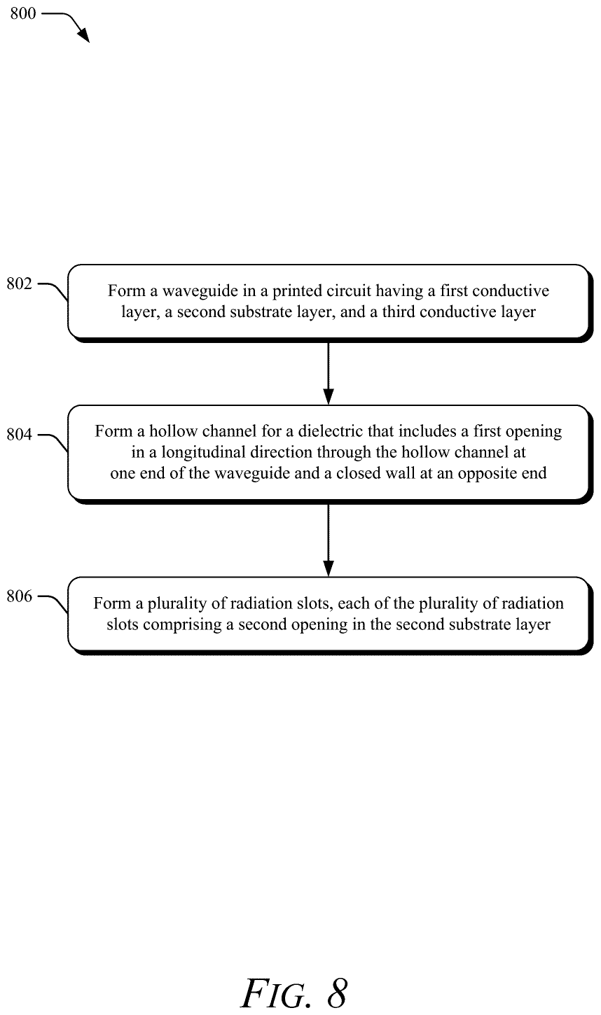

FIG. 7 illustrates an example method 700 that can be used for manufacturing a waveguide with a zigzag waveguide channel for suppressing grating lobes, following techniques, apparatuses, and systems of this disclosure. FIG. 8 illustrates an example method 800, which is part of the method 700, and is for forming a waveguide in part with a printed circuit board, following techniques, apparatuses, and systems of this disclosure.

Methods 700 and 800 are shown as sets of operations (or acts) performed, but not necessarily limited to the order or combinations in which the operations are shown herein. Further, any of one or more of the operations may be repeated, combined, or reorganized to provide other methods. In portions of the following discussion, reference may be made to the environment 100 of FIG. 1 and entities detailed in FIGS. 1 through 6, reference to which is made for example only. The techniques are not limited to performance by one entity or multiple entities.

At 702, a waveguide with a zigzag for suppressing grating lobes is formed. For example, the waveguide 110 can be stamped, etched, cut, machined, cast, molded, or formed in some other way. As another example, the waveguide 504 or the waveguide 604 can be stamped, etched, cut, machined, cast, molded, or formed in some other way. The use of the PCB structure for the waveguide 504 or the waveguide 604 can, for example, provide for cheaper, less complex, and easier manufacturing.

At 704, the waveguide with the zigzag is integrated into a system. For example, the waveguide 110, the waveguide 504, and/or the waveguide 604 is electrically coupled to the antenna 204 as part of the radar system 102.

At 706, electromagnetic signals with suppressed grating lobes in the radiation pattern are received or transmitted via the waveguide with the zigzag at or by an antenna of the system, respectively. For example, the antenna 204 receives or transmits signals with suppressed grating lobes in the three-dimensional radiation pattern via the waveguide 110, the waveguide 504, and/or the waveguide 604 and routed through the radar system 102.

In some examples, the method 800 is performed in executing the step 702 from the method 700. At 802, a waveguide is formed in a printed circuit board (PCB). The waveguide can include a first conductive layer, a second substrate layer, and a third conductive layer. For example, the waveguide 504 includes the first layer 508, the second layer 510, the third layer 512, and the fourth layer 514. The first layer 508, the third layer 512, and the fourth layer 514 are conductive layers. The second layer 510 is a substrate layer. As another example, the waveguide 604 includes the first layer 606, the second layer 608, and the third layer 610. The first layer 606 and the third layer 610 are conductive layers. The second layer 608 is a substrate layer.

At 804, a hollow channel for a dielectric is formed in the waveguide. The hollow channel includes a first opening in a longitudinal direction through the hollow channel at one end of the waveguide and a closed wall at an opposite end. The third conductive layer forms a surface of the hollow channel that defines the hollow channel. For example, the waveguide 504 includes the waveguide channel 506 that is hollow and can hold a dielectric (e.g., air). The waveguide channel 506 includes an opening in the longitudinal direction 206 at one end of the waveguide 504 and a closed wall at an opposite end. The third layer 512 and the fourth layer 514 form side surfaces and a bottom surface, respectively, of the waveguide channel 506. As another example, the waveguide 604 includes the zigzag waveguide channel 112 that is hollow and can hold a dielectric (e.g., air). The zigzag waveguide channel 112 includes an opening in the longitudinal direction 206 at one end of the waveguide 604 and a closed wall at an opposite end. The third layer 610 forms side surfaces and a bottom surface of the zigzag waveguide channel 112.

At 806, a plurality of radiation slots are formed in the waveguide. Each of the plurality of radiation slots include a second opening in the second substrate layer and is operably connected with the dielectric. For example, the waveguide 504 and the waveguide 604 include the radiation slots 114 that are operably connected with the dielectric. For the waveguide 504, the radiation slots 114 are formed in the second layer 510. For the waveguide 604, the radiation slots 114 are formed in the second layer 608.

### Examples

In the following section, examples are provided.

Example 1: An apparatus comprising: a waveguide, the waveguide including: a hollow channel for a dielectric that includes an opening in a longitudinal direction through the waveguide at one end of the waveguide and a closed wall at an opposite end of the waveguide, the hollow channel forming a zigzag shape along the longitudinal direction; and a plurality of radiation slots, each of the plurality of radiation slots comprising another opening through a surface of the waveguide that defines the hollow channel, each of the plurality of radiation slots being operably connected with the dielectric.

Example 2: The apparatus of example 1, wherein: the waveguide includes a printed circuit board (PCB) having at least a conductive layer and a substrate layer, the plurality of radiation slots being formed in the conductive layer of the PCB.

Example 3: The apparatus of example 1, wherein the zigzag shape comprises multiple turns along the longitudinal direction, each of the multiple turns having a turning angle between 0 and 90 degrees.

Example 4: The apparatus of example 1, wherein the plurality of radiation slots is positioned along a centerline of the hollow channel, the centerline being parallel with the longitudinal direction through the hollow channel.

Example 5: The apparatus of example 1, the apparatus further comprising an antenna element electrically coupled to the dielectric from a floor of the hollow channel.

Example 6: The apparatus of example 1, wherein the opening comprises an approximately rectangular shape.

Example 7: The apparatus of example 1, wherein the opening comprises an approximately square shape, oval shape, or circular shape.

Example 8: The apparatus of example 1, wherein the plurality of radiation slots is evenly distributed between the opening and the closed wall along the longitudinal direction.

Example 9: The apparatus of example 1, wherein the waveguide comprises at least one of metal or plastic.

Example 10: The apparatus of example 1, wherein the dielectric comprises air and the waveguide is an air waveguide.

Example 11: An apparatus comprising: a waveguide that includes a printed circuit board (PCB) having a first conductive layer, a second substrate layer, and a third conductive layer, the waveguide including: a hollow channel for a dielectric that includes a first opening in a longitudinal direction through the hollow channel at one end of the waveguide and a closed wall at an opposite end of the waveguide, the third conductive layer forming a surface of the hollow channel that defines the hollow channel; and a plurality of radiation slots, each of the plurality of radiation slots comprising a second opening formed in the second substrate layer, each of the plurality of radiation slots being operably connected with the dielectric.

Example 12: The apparatus of example 11, the apparatus further comprising an antenna element electrically coupled to the dielectric from a floor of the hollow channel.

Example 13: The apparatus of example 11, wherein the first opening comprises an approximately rectangular shape and the hollow channel forming another approximately rectangular shape along the longitudinal direction.

Example 14: The apparatus of example 13, wherein the plurality of radiation slots is offset a non-uniform distance from a centerline of the hollow channel, the centerline being parallel with the longitudinal direction.

Example 15: The apparatus of example 11, wherein the second opening comprises an approximately rectangular shape and the hollow channel forms a zigzag shape along the longitudinal direction through the hollow channel, and wherein the plurality of radiation slots is positioned along a centerline of the hollow channel, the centerline being parallel with the longitudinal direction through the hollow channel.

Example 16: The apparatus of example 11, wherein the first opening comprises an approximately square shape, oval shape, or circular shape.

Example 17: The apparatus of example 11, wherein the plurality of radiation slots is evenly distributed between the first opening and the closed wall along the longitudinal direction.

Example 18: The apparatus of example 11, wherein the waveguide comprises at least one of metal or plastic.

Example 19: The apparatus of example 11, wherein the dielectric comprises air and the waveguide is an air waveguide.

Example 20: An apparatus comprising: a waveguide that includes a printed circuit board (PCB) having a first conductive layer, a second substrate layer, and a third conductive layer, the waveguide including: a hollow channel for a dielectric that includes a first opening in a longitudinal direction through the hollow channel at one end of the waveguide and a closed wall at an opposite end of the waveguide, the third conductive layer forming a surface of the hollow channel that defines the hollow channel, the hollow channel forming a zigzag shape along the longitudinal direction; and a plurality of radiation slots, each of the plurality of radiation slots comprising a second opening formed in the second substrate layer, each of the plurality of radiation slots being operably connected with the dielectric.

### CONCLUSION

While various embodiments of the disclosure are described in the foregoing description and shown in the drawings, it is to be understood that this disclosure is not limited thereto but may be variously embodied to practice within the scope of the following claims. From the foregoing description, it will be apparent that various changes may be made without departing from the scope of the disclosure as defined by the following claims.

What is claimed is:

1. An apparatus comprising:
a waveguide that includes a printed circuit board (PCB) having a first conductive layer, a second substrate layer, and a third conductive layer, the waveguide including:
a hollow channel for a dielectric that includes a first opening in a longitudinal direction through the hollow channel at one end of the waveguide and a closed wall at an opposite end of the waveguide, the third conductive layer forming a surface of the hollow channel that defines the hollow channel; and
a plurality of radiation slots, each of the plurality of radiation slots comprising a second opening formed in the second substrate layer, each of the plurality of radiation slots being operably connected with the dielectric.

2. The apparatus of claim 1, the apparatus further comprising an antenna element electrically coupled to the dielectric from a floor of the hollow channel.

3. The apparatus of claim 1, wherein the first opening comprises an approximately rectangular shape and the hollow channel forming another approximately rectangular shape along the longitudinal direction.

4. The apparatus of claim 3, wherein the plurality of radiation slots is offset a non-uniform distance from a centerline of the hollow channel, the centerline being parallel with the longitudinal direction.

5. The apparatus of claim 1, wherein the second opening comprises an approximately rectangular shape and the hollow channel forms a zigzag shape along the longitudinal direction through the hollow channel, and wherein the plurality of radiation slots is positioned along a centerline of the hollow channel, the centerline being parallel with the longitudinal direction through the hollow channel.

6. The apparatus of claim 1, wherein the first opening comprises an approximately square shape, oval shape, or circular shape.

7. The apparatus of claim 1, wherein the plurality of radiation slots is evenly distributed between the first opening and the closed wall along the longitudinal direction.

8. The apparatus of claim 1, wherein the waveguide comprises at least one of metal or plastic.

9. The apparatus of claim 1, wherein the dielectric comprises air and the waveguide is an air waveguide.

10. An apparatus comprising:
a waveguide that includes a printed circuit board (PCB) having a first conductive layer, a second substrate layer, and a third conductive layer, the waveguide including:
a hollow channel for a dielectric that includes a first opening in a longitudinal direction through the hollow channel at one end of the waveguide and a closed wall at an opposite end of the waveguide, the third conductive layer forming a surface of the hollow channel that defines the hollow channel, the hollow channel forming a zigzag shape along the longitudinal direction; and
a plurality of radiation slots, each of the plurality of radiation slots comprising a second opening formed in the second substrate layer, each of the plurality of radiation slots being operably connected with the dielectric.
